(19) United States
(12) Patent Application Publication
(10) Pub. No.: US 2018/0159429 A1
(43) Pub. Date: Jun. 7, 2018

(54) Auxiliary Supply for a Switched-Mode Power Supply

(71) Applicant: Siemens Aktiengesellschaft, Muenchen (DE)

(72) Inventors: Janusz Dyszewski, Wien (AT); Stefan Reschenauer, Atzelsdorf (AT); Stefan Schulz, Gnadendorf (AT)

(21) Appl. No.: 15/832,163

(22) Filed: Dec. 5, 2017

(30) Foreign Application Priority Data
Dec. 7, 2016 (EP) 16202606.6

(51) Int. Cl. H02M 3/158; H02M 3/335

(52) U.S. Cl. CPC H02M 3/158; H02M 2001/0006; H02M 3/33523

(57) ABSTRACT

An auxiliary supply for a switched mode power supply, which includes at least a transformer with a primary side and a secondary side, wherein the auxiliary supply provides a power supply to units arranged on the secondary side of the switched mode power supply independently of an operating state of the switched mode power supply, where the auxiliary supply in this case, on the primary side, which corresponds to the primary side of the switched mode power supply, has a frequency generator for generating an ac voltage with a predetermined frequency, where on the secondary side, which corresponds to the secondary side of the switched mode power supply, the auxiliary supply has a rectifier unit for a secondary side supply current and/or a secondary side supply voltage, and where a galvanic separation unit, which is particularly formed by two capacitors, is provided between the primary side and the secondary side.

### BACKGROUND OF THE INVENTION

### 1. Field of the Invention

The present invention relates in general to the field of electrical engineering, in particular to the area of power electronics as well as power electronics circuits for power supply and, more specifically, to an auxiliary supply for a power supply or a switched-mode power supply comprising at least one transformer with a primary side and a secondary side, where a power supply independent of the respective operating state is made available for the secondary side by the auxiliary supply.

### 2. Description of the Related Art

Switched-mode power supplies have long been known and are used nowadays in many areas to connect a consumer to a power network or to a power source and to supply the consumer with a mostly constant and frequently predeterminable voltage. The switched-mode power supply converts a mostly non-stabilized DC or AC voltage originating from the power source into a constant output voltage. Voltage converters, which comprise a power transformer or a transformer, are usually used for the conversion of the DC or AC voltage originating from the power source. Flux converters, isolating converters or resonant converters can be used as voltage converters, for example.

Energy or power is transmitted, in such cases, with the aid of the transformer from a primary side of the switched-mode power supply, which is connected to the power network or to the power source, to a secondary side of the switched-mode power supply, at which the output voltage will be made available. In such cases, most switched-mode power supplies, as clocked power supplies, have the characteristic that the instantaneous power value transmitted by them depends directly on the clock ratio, i.e., on the ratio of switch-on and switch-off time of the switching elements used, which are usually switched by a control device. Therefore internal supplies (auxiliary supplies) are used by almost all electronic devices such as switched-mode power supplies, in order to be able to supply the respective control devices or a controller as a whole.

Since, as a result of cost pressure, power supplies, in particular switched-mode power supplies, must be produced ever more cheaply, savings are frequently made in the auxiliary supplies. Thus, for example, savings are made in auxiliary supplies on the secondary side of the switched-mode power supply, because the output voltage of the switched-mode power supply is available on the secondary side in any event. However, particularly in switched-mode power supplies with high demands in respect of efficiency, thermal load and failsafe design, it can increasingly be necessary to provide additional, mostly secondary-side control electronics, which must be supplied with energy independently of the instantaneously available output voltage of the switched-mode power supply. Furthermore, a frequent requirement for future switched-mode power supplies is that a connection option is provided, with which the output voltage is switched off in the event of a short circuit at a signal terminal. In this case too it must be insured that there is a supply of power to components, such as control electronics, or a pilot light, on the secondary side of the switched-mode power supply. However, components located on the secondary side of the transformer can only continue to be supplied by using expensive circuits if an output voltage of the switched-mode power supply is no longer available, such as in the event of a short circuit, on remote switch-off or in a standby mode.

Thus, for example, a separate auxiliary supply with its own auxiliary transformer or auxiliary converter can be provided, which operates independently of the main transformer or main converter of the switched-mode power supply. That is, the secondary-side auxiliary supply is derived, for example, from an auxiliary supply present on the primary side with the aid of an auxiliary converter or auxiliary transformer. With this auxiliary supply, the transformer used, however, must have the same safety gaps between the windings of the coils or the same voltage gaps between primary and secondary side as the main transformer of the switched-mode power supply. This means, for example, that the size of the auxiliary supply for the secondary side or the size of the auxiliary transformer does not depend on the power to be transmitted (mostly rather low) but on the air and creepage gaps. This necessarily produces a rather large construction with the corresponding space requirement on the layout and also high costs associated therewith (for the auxiliary supply and also for the switched-mode power supply).

As an alternative, the auxiliary supply for the secondary side of the switched-mode power supply can also be realized, for example, with the aid of the converter or transformer used in the switched-mode power supply. To this end, a second secondary winding is provided on the transformer of the switched-mode power supply, for example. In order, in the event of a short circuit or when no output voltage is provided at the switched-mode power supply on the secondary side for an auxiliary supply (e.g., with remote switch-off or in standby mode), the output voltage is loaded internally with a basic load. This usually minimal or controlled basic load still enables energy for the secondary-side supply to be coupled out via the second secondary winding on the secondary side. That is, the transformer of the converter, to do this, must permanently deliver at least one amount of energy/power necessary for the supply of the secondary side. Through this type of auxiliary supply of the secondary side the losses will be increased on account of the necessary basic load. Furthermore, a specific, if necessary cost-intensive, controller is needed in order, on the one hand, not to destroy too much power through the basic load and in order, on the other hand, to still make enough power for the secondary-side auxiliary supply available.

### SUMMARY OF THE INVENTION

In view of the foregoing, it is an object of the invention to therefore provide an auxiliary supply for a switched-mode power supply, through which, in a low-cost manner and in a compact design, a supply of a secondary side of the switched-mode power supply is possible even without an available output voltage of the switched-mode power supply.

This and other objects and advantages are achieved in accordance with the invention by an auxiliary supply for a switched-mode power supply, comprising at least a transformer with a primary side and a secondary side. In accordance with the invention, a voltage supply of units arranged on the secondary side of the switched-mode power supply is made available by the auxiliary supply independently of an operating mode of the switched-mode power supply. The auxiliary supply in this case, on the primary side, which corresponds to the primary side of the switched-mode power supply, has a frequency generator, in particular a high frequency generator, for creating an AC voltage with a predetermined frequency. On the secondary side, which corresponds to the secondary side of the switched-mode power supply, the auxiliary supply has a rectifier unit for a secondary-side supply current and/or a secondary-side supply voltage. A galvanic separation unit is also provided between the primary side and the secondary side.

The main aspect of the solution proposed in accordance with the invention consists of generating an auxiliary supply for the secondary side of the switched-mode power supply and of applying an AC voltage with a predetermined frequency to the galvanic separation unit. This AC voltage is generated by the frequency generator arranged on the primary side and can be rectangular, triangular or sinusoidal, for example. Through this an AC voltage or an alternating current will be transmitted from the primary side to the secondary side of the switched-mode power supply via the separation unit. This AC voltage or this alternating current can then be tapped of via the rectifier unit arranged on the secondary side and employed for the supply of units arranged on the secondary side, such as control electronics, or pilot lights. Ideally, largely standard components and/or standard assemblies can be used for a realization of the inventive auxiliary supply, whereby the auxiliary supply or the corresponding switched-mode power supply is able to be manufactured at relatively low cost. Furthermore, the auxiliary supply or the corresponding switched-mode power supply can be realized in a compact form.

In a preferred embodiment of the inventive auxiliary supply, series resistors are arranged on the primary side between the frequency generator and the galvanic separation unit. In such cases, for example, a series resistor can be fitted in each connection between the frequency generator and the galvanic separation unit. Through the use of the series resistors, the auxiliary supply is additionally able to be used for a transmission of information from the secondary side to the primary side of the switched-mode power supply. The galvanic separation unit can be controlled via the series resistors. If a load is now imposed on the secondary-side output of the auxiliary supply, then the secondary supply voltage changes at the output of the auxiliary supply. This also has effects on the ac voltage on the primary side, e.g., at the input of the galvanic separation unit. Through the change of the AC voltage on the primary side a change of the secondary supply voltage can be identified and evaluated accordingly.

Advantageously an evaluation unit, which is arranged on the primary side, is provided for an evaluation of the secondary supply voltage or a change of the secondary supply voltage. The evaluation unit uses the change of the primary-side AC voltage for the evaluation and from this, with known primary-side series resistors, can derive a resistor at the output of the auxiliary supply. The evaluation of the primary-side AC voltage as well as a derivation of the resistor at the output of the auxiliary supply can be achieved by analog or digital means. A respective evaluation result can then be further processed accordingly. In this simple way, by a passive signal on the secondary side, such as an opening and closing of a contact, which is arranged at the output of the inventive auxiliary supply, or through a change of a resistor at the output of the inventive auxiliary supply information can be transferred to the primary side. The contact for the secondary-side signal at the output of the auxiliary supply is at floating potential and can be applied, for example, to ground potential or to another potential. Through the rectifier unit, it is also possible in this way to realize the short circuit contact over a longer distance or over a longer line, because only direct current has to be switched.

It is further advantageous for the frequency of the AC voltage, which is generated by the frequency generator, to be able to be adjusted such that the galvanic separation unit exhibits an impedance minimum. Through this the evaluation of the secondary-side supply voltage is particularly influenced as little as possible by the primary-side evaluation unit or a derivation of the resistor at the output of the auxiliary supply. Ideally an ac voltage with a high frequency is generated, e.g., in a range of 100 kHz to 1 MHz.

In a preferred further embodiment of the inventive auxiliary supply, the galvanic separation unit is realized by two capacitors, which are connected via the rectifier unit on the secondary side in series. The energy is thus transmitted from the primary side to the secondary side capacitively. Furthermore, the use of capacitors offers the advantage of standard electronic components being able to be used and of the auxiliary supply being able to be realized in a compact form and at low cost. For safety reasons, the capacitors with which the galvanic separation unit is realized are formed as Y1 capacitors.

As an alternative, the galvanic separation unit can also be designed as a transformer, where, however, a voltage gap between primary and secondary side is to be noted.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained by way of examples below on the basis of the enclosed figures, in which:

FIG. 1 shows an exemplary schematic diagram of a simple configuration of the auxiliary supply for a secondary side of a switched-mode power supply in accordance with the invention; and

FIG. 2 shows an exemplary embodiment of the auxiliary supply of FIG. 1 with a capacitive, galvanic separation unit, which is also able to be used for evaluating a secondary-side supply voltage.

### DETAILED DESCRIPTION OF THE EXEMPLARY EMBODIMENTS

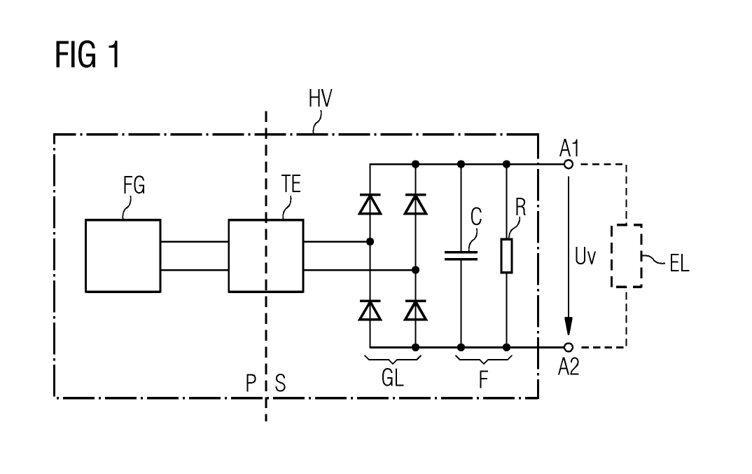

FIG. 1 shows an exemplary schematic diagram of an embodiment of an auxiliary supply HV in its simplest form. The inventive auxiliary supply HV is used in a switched-mode power supply, where for reasons of improved clarity, the switched-mode power supply is not shown in FIG. 1. The switched-mode power supply comprises at least one transformer or a converter that includes a transformer, in order to establish a galvanic separation between a primary side P and a secondary side S. Here, a connection to a power source or a power network is usually located on the primary side P of the switched-mode power supply. An output voltage for connection of a load or a consumer will be delivered on the secondary side S of the switched-mode power supply.

For a supply of units EL arranged on the secondary side S of the switched-mode power supply independent of the operating state of the switched-mode power supply, such as secondary-side control electronics, a pilot light, or a display, an auxiliary supply HV is provided. A supply current and/or a supply voltage Uv are provided on the secondary side for these units EL by the auxiliary supply HV.

To this end, the inventive auxiliary supply HV, on a primary side P, which corresponds to the primary side P of the switched-mode power supply, i.e., this side of the auxiliary supply is connected to the respective power source or to the respective power network, has a frequency generator FG, which in particular can be formed as a high frequency generator, in order to generate an AC voltage in the high kHz or MHz range. An AC voltage with a predetermined frequency is generated by the frequency generator FG. The AC voltage in this case can be rectangular, triangular or sinusoidal. The frequency of the frequency generator FG is settable such that a galvanic separation unit TE, which is connected to the frequency generator FG, exhibits an impedance minimum.

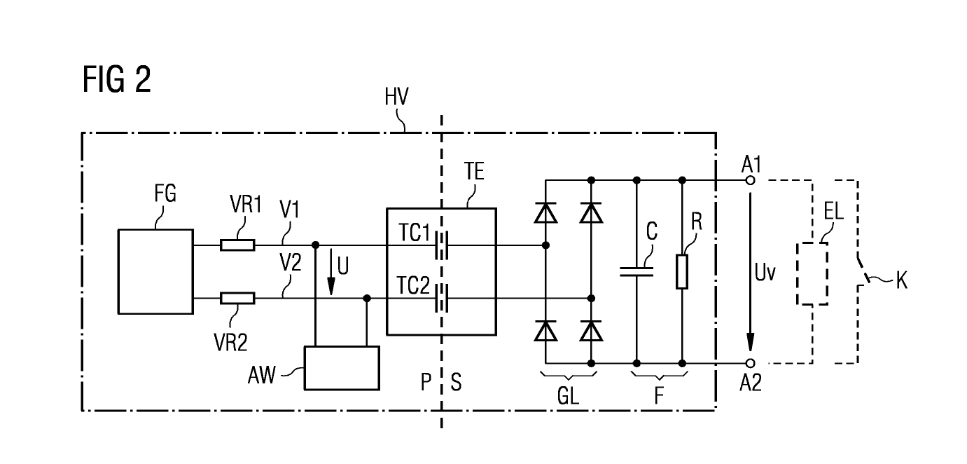

The galvanic separation unit TE connected to the frequency generator FG separates the primary side P of the auxiliary supply HV from a secondary side S of the auxiliary supply HV, which corresponds to the secondary side or the output side of the switched-mode power supply. The galvanic separation unit TE can be realized (as explained later with reference to FIG. 2) by two capacitors TC1, TC2. As an alternative, the galvanic separation unit TE can be formed as a transformer.

On the secondary side, the galvanic separation unit TE is connected to a rectifier unit GL (consisting of four diodes, for example). With the aid of the rectifier unit GL, a supply current or a supply voltage Uv is made available on the secondary side for secondary-side devices EL of the switched-mode power supply. The supply voltage Uv can be tapped off, for example, on the secondary side S of the switched-mode power supply or of the auxiliary supply HV at the output of the rectifier unit GL, for example at terminals A1, A2. That is, a secondary-side device EL such as a control logic, or a pilot light is connectable at these terminals A1, A2. In this case, the terminals A1, A2 are at floating potential, i.e., they can be applied to any given potential or to ground potential. The supply voltage Uv able to be tapped off at the terminals A1, A2 is independent of the respective operating state of the switched-mode power supply.

An additional filtering, which consists of a capacitor C and a resistor R, can optionally be provided on the secondary side S of the auxiliary supply HV. Here, the filtering F is attached on the output side to the rectifier unit GL, in order to smooth the supply voltage Uv created by the rectifier unit GL, for example.

Shown in FIG. 2 is a specific, especially preferred embodiment of the inventive auxiliary supply HV for a switched-mode power supply. With the auxiliary supply HV shown in FIG. 2 by way of example and schematically, as well as a supply of secondary-side devices EL independently of the operating state of the switched-mode power supply, the secondary-side supply voltage Uv or a secondary-side load at output A1, A2 of the auxiliary supply HV can also be evaluated.

To this end, the auxiliary supply HV, on the primary side, has the frequency generator FG for generating an AC voltage with a predetermined frequency. On the secondary side, the rectifier unit GL, for example, consisting of four diodes, is again provided, from which a supply current or a supply voltage Uv for secondary-side devices EL of the switched-mode power supply is made available at output A1, A2. As an alternative, a contact K can be provided at output A1, A2, via which the output A1, A2 of the auxiliary supply HV or of the rectifier unit GL is able to be short-circuited. Furthermore, on the secondary side S at the output of the rectifier unit GL, the filtering F, consisting of the capacitor C and the resistor R, can optionally be attached.

For separation of the primary side P and secondary side S, the auxiliary supply HV in accordance with FIG. 2 likewise comprises the separation unit TE. This separation unit TE is realized, for example, by two capacitors TC1, TC2, where the two capacitors TC1, TC2 are connected in series via the secondary-side rectifier unit GL. For reasons of safety or so that, for example, the contact K can be safely opened or closed by a user, the capacitors TC1, TC2 of the separation unit TE are formed, for example, as Y1 capacitors. Y1 capacitors (for example, in accordance with the appropriate IEC Norm) thus have an increased insulation or a checkable increased electrical and mechanical safety and may therefore be used between the primary side P, which is connected to a power source or to the power network, and the secondary side S. As an alternative, the separation unit TE can be formed as a transformer.

For evaluation of the secondary-side supply voltage Uv or of the secondary-side load at output A1, A2 of the auxiliary supply, there are also at least two series resistors VR1, VR2 provided on the primary side P. The series resistors VR1, VR2 are attached between the frequency generator FG and the separation unit TE. If the separation unit TE (as shown FIG. 2) is realized by two capacitors TC1, TC2, then a first series resistor VR1 is arranged in a first connection V1 between the frequency generator FG and a first capacitor TC1 of the separation unit TE and a second series resistor VR2 in a second connection V2 between the frequency generator FG and a second capacitor TC2 of the separation unit TE. Furthermore the auxiliary supply HV, on the primary side P, includes an evaluation unit AW, which is linked to the connections V1, V2.

In order to generate a supply current or a supply voltage Uv on the secondary side S, an AC voltage with a predetermined frequency is generated by the frequency generator FG and this AC voltage is applied to the separation unit TE or to the two capacitors TC1, TC2. Here, the predetermined frequency of the AC voltage is selected so that the impedance of the separation unit TE or of the two capacitors TC1, TC2 is at a minimum. Usually an ac voltage with a high frequency (e.g., 100 kHz, or 1 MHz) is generated.

Through the primary-side application to the separation unit TE, an AC current or an AC voltage is transmitted by the separation unit TE to the secondary side S. In a separation unit TE, which consists of two capacitors TC1, TC2, there is an alternating current flow through the capacitors TC1, TC2, for example, which can be tapped off on the secondary side via the rectifier unit GL.

For evaluation of the supply voltage Uv or the load at output A1, A2 of the auxiliary supply HV, the separation unit TE or the two capacitors TC1, TC2 of the separation unit TE are activated accordingly via the series resistors VR1, VR2. If the output A1, A2 of the auxiliary supply HV or of the rectifier unit GL is now loaded with a device EL or is short-circuited via a contact K, then the AC voltage U also collapses accordingly on the primary side. This change of the AC voltage U can be detected and evaluated via the evaluation unit AW. The evaluation of the primary-side ac voltage U as well as a derivation of the load or of a resistor at output A1, A2 of the auxiliary supply HV can be achieved either by analog or by digital means. The results established with the evaluation unit AW can then be further processed accordingly. In this way a passive signal on the secondary side S, such as an opening and/or closing of the contact K at output A1, A2 of the auxiliary supply HV or a change of the resistor EL at output A1, A2 of the auxiliary supply HV, can be transmitted as information to the primary side P of the auxiliary supply.

When a contact K is used for a secondary-side signal at output A1, A2 of the auxiliary supply HV, this contact K is at floating potential and can, for example, be applied to the ground potential or to another potential. The information transmitted from the secondary side S to the primary side P (e.g., opening and/or closing of the contact K) can be used, for example, for switching-on and switching-off the switched-mode power supply.

If, as an alternative, for example, a change of the voltage Uv or of the load resistance EL at output A1, A2 of the auxiliary supply HV is evaluated, then the output A1, A2 of the auxiliary supply can be used, for example, for a realization of a display of a level.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An auxiliary supply for a switched mode power supply including at least one transformer having a primary side and a secondary side, the auxiliary supply providing a power supply to units arranged on the secondary side of the switched mode power supply independently of an operating state of the switched mode power supply, the auxiliary supply comprising:
a frequency generator arranged on the primary side of the at least one transformer for generating an AC voltage with a predetermined frequency;
a rectifier unit arranged on the secondary side of the at least one transformer for generating at least one of (i) a secondary side supply current and (ii) a secondary side supply voltage; and
a galvanic separation unit operatively coupled between the primary side and the secondary side of the at least one transformer.

2. The auxiliary supply as claimed in claim 1, further comprising:
series resistors operatively connected, on the primary side of the at least one transformer, between the frequency generator and the galvanic separation unit.

3. The auxiliary supply as claimed in claim 1, further comprising:
an evaluation unit arranged on the primary side of the at least one transformer for evaluating the secondary side supply voltage.

4. The auxiliary supply as claimed in claim 2, further comprising:
an evaluation unit arranged on the primary side of the at least one transformer for evaluating the secondary side supply voltage.

5. The auxiliary supply as claimed in claim 1, wherein the frequency of the AC voltage generated by the frequency generator is settable such that the galvanic separation unit exhibits an impedance minimum.

6. The auxiliary supply as claimed in claim 2, wherein the frequency of the AC voltage generated by the frequency generator is settable such that the galvanic separation unit exhibits an impedance minimum.

7. The auxiliary supply as claimed in claim 3, wherein the frequency of the AC voltage generated by the frequency generator is settable such that the galvanic separation unit exhibits an impedance minimum.

8. The auxiliary supply as claimed in claim 1, wherein the galvanic separation unit is formed by two capacitors connected in series via the rectifier unit arranged on the secondary side of the at least one transformer.

9. The auxiliary supply as claimed in claim 2, wherein the galvanic separation unit is formed by two capacitors connected in series via the rectifier unit arranged on the secondary side of the at least one transformer.

10. The auxiliary supply as claimed in claim 3, wherein the galvanic separation unit is formed by two capacitors connected in series via the rectifier unit arranged on the secondary side of the at least one transformer.

11. The auxiliary supply as claimed in claim 5, wherein the galvanic separation unit is formed by two capacitors connected in series via the rectifier unit arranged on the secondary side of the at least one transformer.

12. The auxiliary supply as claimed in claim 8, wherein the capacitors of the galvanic separation unit comprise Y1 capacitors.

13. The auxiliary supply as claimed in claim 1, wherein the galvanic separation unit comprises a transformer.

14. The auxiliary supply as claimed in claim 1, wherein the frequency generator comprises a high frequency generator.
